(19) United States
(12) Patent Application Publication
(10) Pub. No.: US 2025/0193225 A1
(43) Pub. Date: Jun. 12, 2025

(54) INFORMATION PROCESSING APPARATUS, INFORMATION PROCESSING METHOD, AND COMPUTER READABLE RECORDING MEDIUM

(71) Applicant: NEC Corporation, Minato-ku, Tokyo (JP)

(72) Inventor: Masaru KAWAKITA, Tokyo (JP)

(73) Assignee: NEC Corporation, Minato-ku, Tokyo (JP)

(21) Appl. No.: 18/840,533

(22) PCT Filed: Mar. 18, 2022
(86) PCT No.: PCT/JP2022/012784

§ 371 Date: Aug. 22, 2024

(51) Int. Cl. H04L 9/40

(52) U.S. Cl. CPC H04L 63/1433

(57) ABSTRACT

An information processing apparatus including: an extracting unit extracts a first protocol information and a port number from vulnerability description information; a first determining unit that: (a) extracts second protocol information and transmission-destination port number from using the first protocol and the port number; (b) generates frequency distribution information by using the extracted second protocol and transmission-destination port number; (c) calculates curve information indicating a curve by executing smoothing processing on the frequency distribution information; (d) calculate a processing result by executing definite integral processing on the curve information; and (e) first determine presence/absence of an actual attack using the processing result and a threshold; and a severity assessing unit that calculates a severity based on the reported-case-of-exploitation presence/absence information included in the vulnerability information and a result of the determination of the presence/absence of an actual attack.

### TECHNICAL FIELD

The technical field relates to an information processing apparatus and an information processing method for cybersecurity risk assessment, and further relates to a computer readable recording medium including recorded thereon a program for realizing the information processing apparatus and information processing method.

### BACKGROUND ART

Cyberattacks performed by unauthorized access targeting nations, critical infrastructure, companies, organizations, etc., have become a social issue. In Japan, the Amendment of the Act on the Protection of Personal Information in June 2020 made it mandatory to report the leakage of personal information due to cyberattacks to the affected principals and the Personal Information Protection Commission, regardless of the number of cases of leakage.

In other words, an affected organization needs to publicly announce the leakage of client information or the occurrence of a system failure. However, when the occurrence of these is reported in the mass-media, for example, the incurrence of significant costs for post-incident responses, such as a drop in stock prices and an investigation of the scope of impact.

In view of this, in order to ascertain such a business risk beforehand, security risk assessment is conducted to identify vulnerabilities inherent in an information system.

As a related technique, Patent Document 1 discloses an unauthorized-access integrated handling system. For each site that is connected to a wide-area computer network, the unauthorized-access integrated handling system in Patent Document 1 uses a generalized log format and aggregates various types of log information from multiple types of unauthorized-access-related sensors and component devices in the site. Next, the unauthorized-access integrated handling system associates logs of multiple types of sensors and component devices from the aggregated logs to integrally detect an unauthorized access.

As a related technique, Patent Document 2 discloses a security management apparatus. If an abnormality relating to some kind of unauthorized access is detected in abnormality-detection-based intrusion detection, the security management apparatus in Patent Document 2 specifies what kind of unauthorized access has been detected.

As a related technique, Patent Document 3 discloses an information processing apparatus that performs efficient apparatus control in accordance with the severity of a vulnerability in a state in which the actual operational environment is taken into consideration in the severity. According to the information processing apparatus in Patent Document 3, the severity is calculated based on actual-operational-environment information and vulnerability information, and the information processing apparatus is controlled in accordance with the severity.

As a related technique, Patent Document 4 discloses a business-processing-system monitoring apparatus that detects an attack against a business processing system including a plurality of computers, and analyzes the effect of the detected attack. The business-processing-system monitoring apparatus in Patent Document 4 analyzes the effect of an attack against one or more of the computers based on the importance of information processing activity executed by each computer, the system configuration of each computer, and a result of detection of an attack against each computer.

### LIST OF RELATED ART DOCUMENTS

### Patent Document

Patent Document 1: Japanese Patent Laid-Open Publication No. 2005-202664
Patent Document 2: Japanese Patent Laid-Open Publication No. 2008-167099
Patent Document 3: Japanese Patent Laid-Open Publication No. 2014-174678
Patent Document 4: Japanese Patent Laid-Open Publication No. 2017-211978

### SUMMARY OF INVENTION

### Problems to be Solved by the Invention

However, according to Patent Documents 1 to 4, system renovation is required to address vulnerabilities identified by security risk assessment. Furthermore, as the number of vulnerabilities to be resolved increases, man-hours required for coding and testing increase. Thus, in order to effectively address vulnerabilities, it is necessary to accurately ascertain the severity of the vulnerabilities.

As an assessment method for measuring the severity of vulnerabilities, there is known a method of using the Common Vulnerability Scoring System (CVSS), in which determination is performed using exploitability, etc. However, because only some of those vulnerabilities determined as having high severity are exploited for actual attacks, the cost-effectiveness of measures taken against vulnerabilities would not be sufficient.

For example, the presence/absence of an actual attack can be determined based on observed data. Furthermore, it can be determined that there has been an actual attack exploiting a remotely exploitable vulnerability if a certain number of attack attempts have been made to a specific communication port.

However, a large number of observation apparatuses would be necessary to observe a plurality of actual attacks. However, the number of observation apparatuses cannot be increased easily. In view of this, it is conceivable to open a plurality of communication ports using one observation apparatus, for example. However, an attacker would suspect an apparatus having a plurality of open communication ports as likely being an observation apparatus, and thus may abort an attack attempt.

An example object is to provide an information processing apparatus, an information processing method, and a computer readable recording medium for accurately assessing the severity of vulnerabilities by comprehensively recognizing the presence/absence of actual attacks.

### Means for Solving the Problems

In order to achieve the example object described above, an information processing apparatus according to an example aspect includes:
an extracting unit that extracts, from vulnerability description information that is included in vulnerability information stored in a storage device and that indicates a description regarding a vulnerability, first protocol information indicating a first protocol for communication and port number information indicating a port number for communication;
a first determining unit that: (a) extracts second protocol information indicating a second protocol and transmission-destination port number information indicating a transmission-destination port number from a log obtained as a result of an observation apparatus connected to a network performing communication using the first protocol and the port number; (b) generates frequency distribution information by using the extracted second protocol and transmission-destination port number and obtaining the number of instances of communication during each of a plurality of preset sampling periods that are arranged in a time series within a preset determination period; (c) calculates curve information indicating a curve by executing smoothing processing on the generated frequency distribution information; (d) calculates a processing result by executing definite integral processing on the generated curve information; and (e) determines presence/absence of an actual attack using the calculated processing result and a preset threshold; and
a severity assessing unit that acquires reported-case-of-exploitation presence/absence information that is included in the vulnerability information and that indicates presence/absence of a reported case of exploitation of the target vulnerability, and calculate a severity based on the reported-case-of-exploitation presence/absence information and a result of the determination of the presence/absence of an actual attack.

Also, in order to achieve the example object described above, an information processing method that is performed by an information processing apparatus according to an example aspect includes:
an extraction processing of extracting, from vulnerability description information that is included in vulnerability information stored in a storage device and that indicates a description regarding a vulnerability, first protocol information indicating a first protocol for communication and port number information indicating a port number for communication;
a first determination processing of: (a) extracting second protocol information indicating a second protocol and transmission-destination port number information indicating a transmission-destination port number from a log obtained as a result of an observation apparatus connected to a network performing communication using the first protocol and the port number; (b) generating frequency distribution information by using the extracted second protocol and transmission-destination port number and obtaining the number of instances of communication during each of a plurality of preset sampling periods that are arranged in a time series within a preset determination period; (c) calculating curve information indicating a curve by executing smoothing processing on the generated frequency distribution information; (d) calculating a processing result by executing definite integral processing on the generated curve information; and (e) determining presence/absence of an actual attack using the calculated processing result and a preset threshold; and
a severity assessment processing of acquiring reported-case-of-exploitation presence/absence information that is included in the vulnerability information and that indicates presence/absence of a reported case of exploitation of the target vulnerability, and calculating a severity based on the reported-case-of-exploitation presence/absence information and a result of the determination of the presence/absence of an actual attack.

Furthermore, in order to achieve the example object described above, a computer-readable recording medium according to an example aspect includes a program recorded on the computer-readable recording medium, the program including instructions that cause the computer to carry out:
an extraction processing of extracting, from vulnerability description information that is included in vulnerability information stored in a storage device and that indicates a description regarding a vulnerability, first protocol information indicating a first protocol for communication and port number information indicating a port number for communication;
a first determination processing of: (a) extracting second protocol information indicating a second protocol and transmission-destination port number information indicating a transmission-destination port number from a log obtained as a result of an observation apparatus connected to a network performing communication using the first protocol and the port number; (b) generating frequency distribution information by using the extracted second protocol and transmission-destination port number and obtaining the number of instances of communication during each of a plurality of preset sampling periods that are arranged in a time series within a preset determination period; (c) calculating curve information indicating a curve by executing smoothing processing on the generated frequency distribution information; (d) calculating a processing result by executing definite integral processing on the generated curve information; and (e) determining presence/absence of an actual attack using the calculated processing result and a preset threshold; and
a severity assessment processing of acquiring reported-case-of-exploitation presence/absence information that is included in the vulnerability information and that indicates presence/absence of a reported case of exploitation of the target vulnerability, and calculating a severity based on the reported-case-of-exploitation presence/absence information and a result of the determination of the presence/absence of an actual attack.

### Advantageous Effects of the Invention

As one aspect, the severity of vulnerabilities can be assessed accurately by comprehensively recognizing the presence/absence of actual attacks.

### BRIEF DESCRIPTION OF THE DRAWINGS

FIG. 1 is a diagram for describing an example of the information processing apparatus.

FIG. 2 is a diagram for describing an example of a communication-count frequency distribution and smoothing.

FIG. 3 is a diagram for describing the data structure of the severity determination information.

FIG. 4 is a diagram for describing an example of a system including the information processing apparatus according to example embodiment 1.

FIG. 5 is a diagram for describing an example of operations of the information processing apparatus.

FIG. 6 is a diagram for describing an example of a difference between a model curve and a curve within a determination period.

FIG. 7 is a diagram for describing the data structure of the severity determination information according to modification 2.

FIG. 8 is a diagram for describing an example of a computer that realizes the information processing apparatus in the example embodiment 1 and modifications 1 to 3.

### EXAMPLE EMBODIMENT

In the following, an example embodiment will be described with reference to the drawings. Note that, in the drawings described in the following, the same reference symbol is given to elements having the same function or corresponding functions, and repetitive description thereof may be omitted.

### Example Embodiment 1

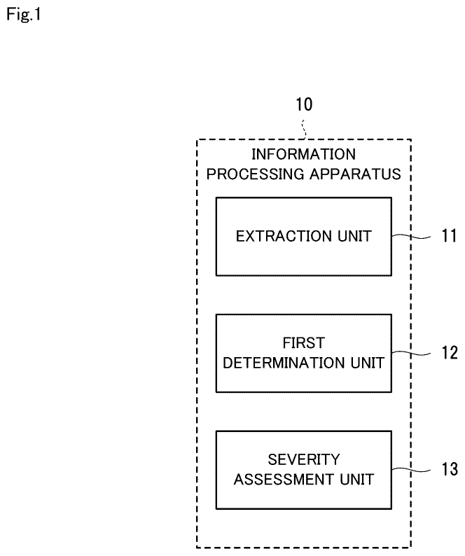

A configuration of an information processing apparatus 10 in example embodiment 1 will be described with reference to FIG. 1. FIG. 1 is a diagram for describing an example of the information processing apparatus.

### [Apparatus Configuration]

The information processing apparatus 10 illustrated in FIG. 1 is an apparatus that accurately assesses the severity of vulnerabilities by comprehensively recognizing the presence/absence of actual attacks. Furthermore, as illustrated in FIG. 1, the information processing apparatus 10 includes an extraction unit 11, a first determination unit 12, and a severity assessment unit 13.

The extraction unit 11 extracts, from vulnerability description information that is included in vulnerability information stored in a storage device and that indicates a description regarding a vulnerability, first protocol information indicating a first protocol for communication and port number information indicating a port number for communication.

The storage device is a database or the like that is provided outside the information processing apparatus 10. The storage device stores one or more pieces of the vulnerability information.

For example, the vulnerability information is information that has been generated in advance using information regarding a publicly disclosed vulnerability (information regarding a vulnerability that has been collected from a vulnerability information database or the like), information regarding a zero-day vulnerability (a vulnerability that has not been publicly disclosed yet or a vulnerability a correction program for which has not been released yet), or the like.

A vulnerability information database is a platform disclosed to the public that has been constructed by compiling vulnerability-related information into a database, and is a database such as the Common Vulnerabilities and Exposures (CVE), National Vulnerability Database (NVD), Japan Vulnerability Notes (JVN), JVN iPedia, Open Source Vulnerability Database (OSVDB), or the like, for example.

The vulnerability information at least includes vulnerability identification information, vulnerability disclosure date/time information, reported-case-of-exploitation presence/absence information, remote-attack possibility information, vulnerability description information, exploit-code information, exploit-code disclosure date/time information, etc.

The vulnerability identification information is information identifying each piece of vulnerability information. For example, if the vulnerability information has been generated based on information acquired from CVE (vulnerability information database), it is conceivable to use CVE-ID as the vulnerability identification information. The vulnerability disclosure date/time information is information indicating the year, month, day, and hour of public disclosure of the vulnerability information.

The reported-case-of-exploitation presence/absence information is information indicating the presence/absence of a reported case of exploitation of the target vulnerability. If a reported case of exploitation of the target vulnerability is present, “1” is set to reported-case-of-exploitation presence/absence information K, for example. If no reported case of exploitation of the target vulnerability is present, “0” is set to the reported-case-of-exploitation presence/absence information K, for example.

The remote-attack possibility information is information indicating whether or not there is a possibility of a remote attack being executed using the target vulnerability. If there is a possibility of a remote attack, “1” is set to remote-attack possibility information R, for example. If there is no possibility of a remote attack, “0” is set to the remote-attack possibility information R, for example.

The vulnerability description information is information indicating a description regarding the target vulnerability. For example, if the vulnerability information has been generated based on information acquired from CVE (vulnerability information database), the vulnerability description information is text information included in the “Description” or the like of a website in which CVE is publicly disclosed.

The exploit-code information is information indicating a location where an exploit code is publicly disclosed. For example, the information indicating the location where an exploit code is publicly disclosed is a Uniform Resource Locator (URL) of a website in which the exploit code is publicly disclosed. The exploit-code disclosure date/time information is information indicating the year, month, day, and hour of public disclosure of the exploit code.

In regard to the first protocol information and the port number information, for example, the first protocol and the port number included in the vulnerability description information are extracted by conventional text extraction processing in which regular expressions are used.

Note that, if the first protocol and the port number cannot be obtained from the vulnerability description information, the first protocol and the port number may be extracted from text information in a location where the exploit code corresponding to the target vulnerability is publicly disclosed, for example.

The first determination unit 12 first extracts second protocol information indicating a second protocol and transmission-destination port number information indicating a transmission-destination port number from a log obtained as a result of an observation apparatus connected to a network performing communication using the first protocol and the port number.

The log is information indicating a history of communication performed using a socket corresponding to the port number and the first protocol. At least the year, month, day, and hour of communication, a transmission-source IP address, the second protocol, and the transmission-destination port number are recorded in the log.

For example, the second protocol information and the transmission-destination port number information are extracted from the log by conventional text extraction processing in which regular expressions are used.

Next, the first determination unit 12 generates frequency distribution information by using the extracted second protocol and transmission-destination port number and obtaining the number of instances of communication (communication count) during each of a plurality of preset sampling periods that are arranged in a time series within a preset determination period.

The determination period is a period that is represented using a preset starting time point t1 (year, month, day, and hour) and a preset time length T or ending time point t2 (year, month, day, and hour). For example, the starting time point t1 is a time point (year, month, day, and hour) that is no earlier than the time point of public disclosure of the exploit code corresponding to the vulnerability information. For example, the starting time point t1 is set by the user. For example, the time length T or ending time point t2 is set based on a result of an experiment or simulation, or set by the user. Note that it is conceivable to set the determination period to 30 days or the like, for example.

The frequency distribution information is information indicating the number of instances of communication (communication count) performed during each of a plurality of sampling periods Ts (intervals) that are arranged in a time series within the determination period. For example, the sampling period Ts is determined based on a result of an experiment, simulation, or the like. Note that it is conceivable to set the sampling period Ts to one day or the like.

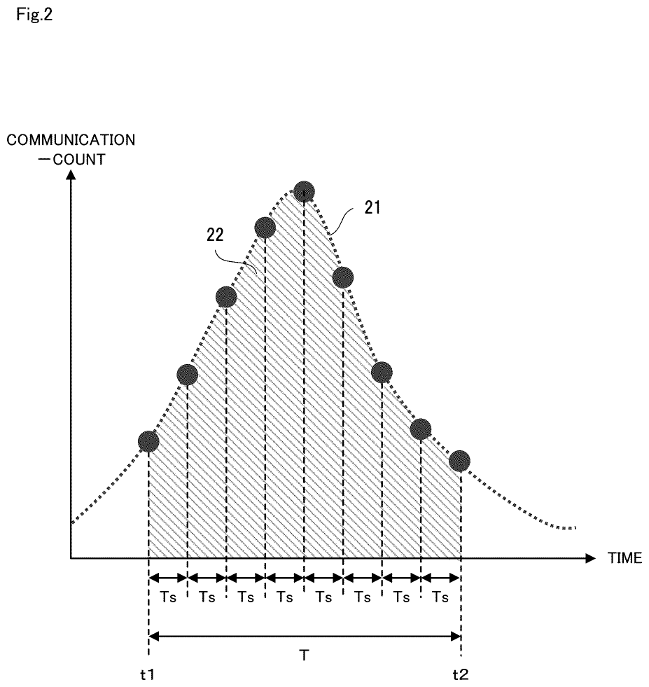

FIG. 2 is a diagram for describing an example of a communication-count frequency distribution and smoothing. FIG. 2 illustrates a frequency distribution graph in which the communication count (black dot) during each sampling period Ts is used.

Next, the first determination unit 12 calculates curve information indicating a curve by executing smoothing processing on the generated frequency distribution information. For example, the smoothing processing is processing such as spline interpolation. For example, curve 21 in FIG. 2 is a curve obtained by performing interpolation using a polynomial for each sampling period Ts.

Next, the first determination unit 12 calculates a processing result D by executing definite integral processing on the generated curve information. The definite integral processing is processing in which a definite integral is performed on the curve corresponding to the determination period. Region 22 (hatched area) in FIG. 2 indicates the processing result D of the definite integral processing.

Next, the first determination unit 12 determines the presence/absence of an actual attack using the calculated processing result D and a preset threshold Th. The threshold Th is information for determining the presence/absence of an actual attack. For example, the threshold Th is a value determined based on a result of an experiment, simulation, or the like.

If the processing result D is greater than or equal to the threshold Th, the first determination unit 12 determines that an actual attack is present and sets “1” to a result A of the determination of an actual attack. If the result D of the definite integral processing is smaller than the threshold Th, the first determination unit 12 determines that no actual attack is present and sets “0” to the result A of the determination of an actual attack.

The severity assessment unit 13 calculates a severity S based on the reported-case-of-exploitation presence/absence information K, which indicates the presence/absence of a reported case of exploitation of the target vulnerability, and the result A of the determination of the presence/absence of an actual attack.

Specifically, first, the severity assessment unit 13 acquires the reported-case-of-exploitation presence/absence information K and the result A of the determination of the presence/absence of an actual attack. Next, the severity assessment unit 13 obtains the severity S by using the reported-case-of-exploitation presence/absence information K and the result A of the determination of the presence/absence of an actual attack and referring to severity determination information for determining the severity S.

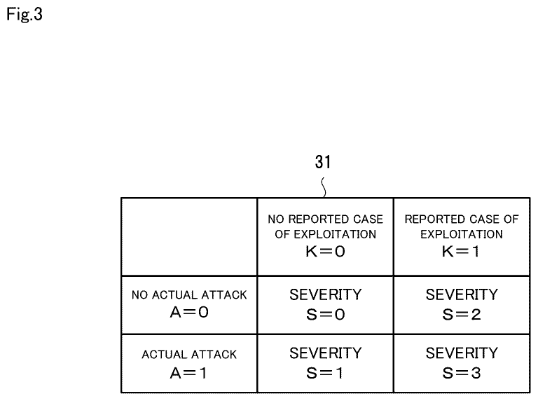

The severity determination information is information for determining the severity S based on the presence/absence of a reported case of exploitation and the presence/absence of an actual attack. FIG. 3 is a diagram for describing the data structure of the severity determination information.

If the reported-case-of-exploitation presence/absence information indicates that no reported case of exploitation is present (K=0) and the result of the determination of an actual attack is that no actual attack is present (A=0) in a case in which severity determination information 31 in FIG. 3 is used, the severity is set to “0” (S=0) because neither a reported case of exploitation nor an actual attack is present. Also, if the reported-case-of-exploitation presence/absence information indicates that no reported case of exploitation is present (K=0) and the result of the determination of an actual attack is that an actual attack is present (A=1), the severity is set to “1” (S=1) because an actual attack is present even though no reported case of exploitation is present.

Also, if the reported-case-of-exploitation presence/absence information indicates that a reported case of exploitation is present (K=1) and the result of the determination of an actual attack is that no actual attack is present (A=0), the severity is set to “2” (S=2) because a reported case of exploitation has already been publicly disclosed. Also, if the reported-case-of-exploitation presence/absence information indicates that a reported case of exploitation is present (K=1) and the result of the determination of an actual attack is that an actual attack is present (A=1), the severity is set to “3” (S=3) because a reported case of exploitation has already been publicly disclosed and an actual attack has also been observed.

The severity is an index indicating how severe the target vulnerability is. In the example in FIG. 3, the severity is an index indicating the security risk in levels. In a case in which index values of four levels are adopted to indicate the severity(S), index values “3”, “2”, “1”, and “0” are set in the order of higher severity, for example. However, the severity S is not limited to having four levels.

For example, the index values “3”, “2”, “1”, and “0” respectively indicate “critical”, “significant”, “warning”, and “vigilance”.

For example, “critical” indicates that the vulnerability may result in a malicious program being executed without any operation by the user. For example, “significant” indicates that the vulnerability may result in violation of the confidentiality, integrity, and availability of the user's data. “Warning” indicates that the vulnerability poses a reduced risk due to exploitation thereof being difficult or other reasons. For example, “vigilance” indicates that the vulnerability is extremely difficult to exploit and only has minimal impact.

Next, the severity assessment unit 13 stores the vulnerability identification information, the reported-case-of-exploitation presence/absence information K, the result A of the determination of an actual attack, the severity S, and information indicating the year, month, day, and hour of assessment of the severity S that are related to the target vulnerability so as to be associated with one another in a storage device.

### [System Configuration]

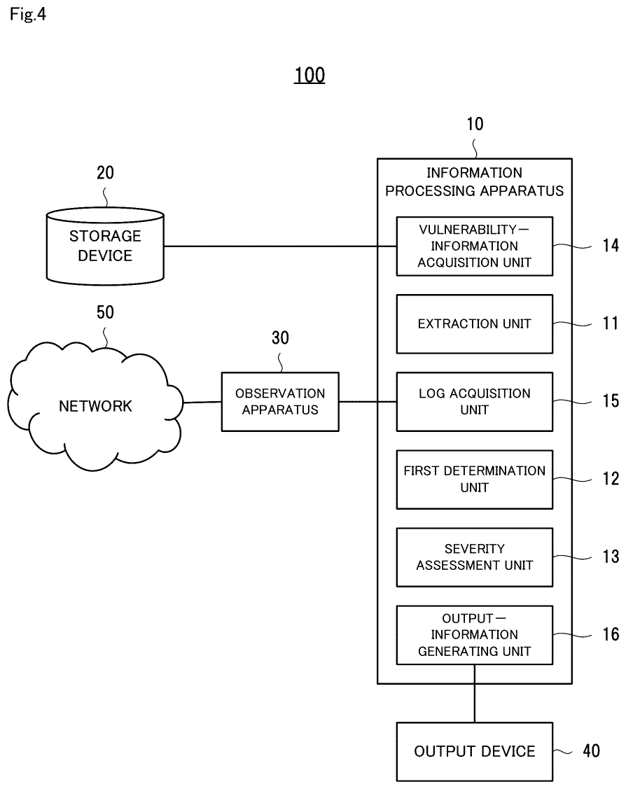

The configuration of the information processing apparatus 10 in example embodiment 1 will be described in detail with reference to FIG. 4. FIG. 4 is a diagram for describing an example of a system including the information processing apparatus according to example embodiment 1.

As illustrated in FIG. 4, a system 100 in example embodiment 1 includes the information processing apparatus 10, a storage device 20, an observation apparatus 30, and an output device 40. The observation apparatus 30 is connected to a network 50.

For example, the information processing apparatus 10 is a central processing unit (CPU), a programmable device such as a field-programmable gate array (FPGA), a graphics processing unit (GPU), or a circuit, a server computer, a personal computer, a mobile terminal, or the like having at least one of a CPU, a programmable device, and a GPU installed therein.

The information processing apparatus 10 is an information-analyzing apparatus (information analysis apparatus) for cybersecurity risk assessment.

The storage device 20 is a database, a server computer, a circuit including a memory, or the like. For example, a vulnerability information database or the like may be used as the storage device 20. While the storage device 20 is provided outside the information processing apparatus 10 in the example in FIG. 4, the storage device 20 may be provided inside the information processing apparatus 10.

The observation apparatus 30 is a computer or the like having software including a communication function mounted thereon. For example, the observation apparatus 30 is an apparatus that performs communication using the first protocol and the port number, and stores, as a log, at least the year, month, day, and hour of communication, the transmission-source IP address, the second protocol, and the transmission-destination port number. Note that one or more observation apparatuses 30 may be provided.

The output device 40 acquires output information that has been converted into an outputtable format by an output-information generation unit 16, and outputs image(s), sound, etc., generated based on the output information. For example, the output device 40 is an image display device in which liquid crystal, organic electroluminescence (EL), or a cathode ray tube (CRT) is used, or the like. Furthermore, the image display device may include a sound output device such as a speaker or the like. Note that the output device 40 may be a printing device such as a printer.

For example, the network 50 is a conventional network that is constructed using a communication line such as the Internet, a Local Area Network (LAN), a dedicated line, a telephone line, an enterprise intranet, a mobile communication network, Bluetooth (registered trademark), or Wireless Fidelity (WiFi).

The information processing apparatus will be described in detail.

In the example in FIG. 4, the information processing apparatus 10 at least includes a vulnerability-information acquisition unit 14, the extraction unit 11, a log acquisition unit 15, the first determination unit 12, the severity assessment unit 13, and the output-information generation unit 16. Note that, because the extraction unit 11, the first determination unit 12, and the severity assessment unit 13 have already been described, description thereof is omitted.

The vulnerability-information acquisition unit 14 first acquires target vulnerability information from the storage device 20. Next, the vulnerability-information acquisition unit 14 outputs the acquired vulnerability information to the extraction unit 11.

The log acquisition unit 15 acquires a log from the observation apparatus 30 having performed communication based on the first protocol and the port number. Next, the log acquisition unit 15 outputs the acquired log to the first determination unit 12.

The output-information generation unit 16 generates output information for presenting to the user at least information regarding the target vulnerability and the severity S of the target vulnerability. Next, the output-information generation unit 16 outputs the output information to the output device 40. Note that the output-information generation unit 16 may generate output information for outputting, to the output device 40, graphs such as a curve and a frequency distribution graph such as those illustrated in FIG. 2.

### [Apparatus Operations]

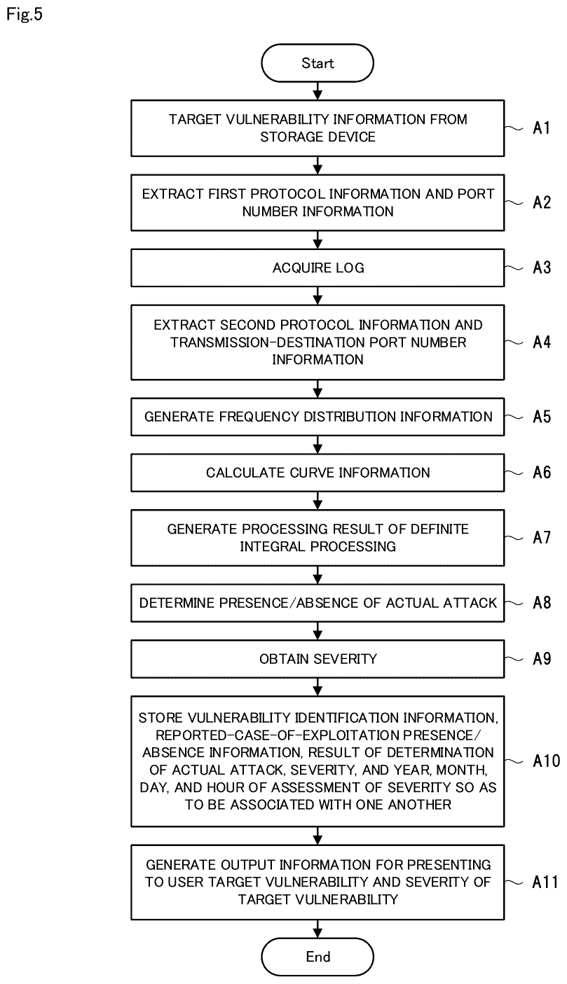

Operations of the information processing apparatus in example embodiment 1 will be described with reference to FIG. 5. FIG. 5 is a diagram for describing an example of operations of the information processing apparatus. Drawings will be referred to as needed in the following description. Furthermore, in example embodiment 1, an information processing method is implemented by causing the information processing apparatus to operate. Accordingly, the following description of the operations performed by the information processing apparatus is substituted for the description of the information processing method in example embodiment 1.

The vulnerability-information acquisition unit 14 first acquires target vulnerability information from the storage device 20 (step A1). In step A1, next, the remote-attack possibility information R and the reported-case-of-exploitation presence/absence information K in the target vulnerability information are referred to, and processing is terminated without processing in and following step A2 being executed if the remote-attack possibility information indicates that there is no possibility of a remote attack (R=0), or if the remote-attack possibility information indicates that there is a possibility of a remote attack (R=1) and the reported-case-of-exploitation presence/absence information indicates that a reported case of exploitation is present (K=1).

This is because network-layer observation cannot be performed for a vulnerability that cannot be exploited remotely, and thus such a vulnerability is excluded from the target of assessment. Furthermore, even if a vulnerability can be exploited remotely, it is unnecessary to take the time and effort to assess the vulnerability should the reported-case-of-exploitation presence/absence information indicate that a reported case of exploitation is present; thus, such a vulnerability is also excluded from the target of assessment.

The processing in and following step A2 is executed if the remote-attack possibility information indicates that there is a possibility of a remote attack (R=1) and the reported-case-of-exploitation presence/absence information indicates that no reported case of exploitation is present (K=0) in step A1. Then, the vulnerability-information acquisition unit 14 outputs the acquired vulnerability information to the extraction unit 11.

Next, the extraction unit 11 extracts first protocol information and port number information by executing text extraction processing on the vulnerability description information included in the acquired target vulnerability information (step A2).

Next, the log acquisition unit 15 acquires a log from the observation apparatus 30 having performed communication based on the first protocol and the port number (step A3). In step A3, next, the log acquisition unit 15 outputs the acquired log to the first determination unit 12.

Next, the first determination unit 12 acquires the log from the log acquisition unit 15. Next, the first determination unit 12 extracts second protocol information and transmission-destination port number information by executing text extraction processing on the acquired log (step A4).

Next, the first determination unit 12 generates frequency distribution information by using the extracted second protocol and transmission-destination port number and obtaining the number of instances of communication (communication count) performed during each of a plurality of sampling periods that are arranged in a time series within a determination period (step A5).

Next, the first determination unit 12 calculates curve information by executing smoothing processing on the generated frequency distribution information (step A6). Next, the first determination unit 12 calculates a processing result D by executing definite integral processing on the generated curve information (step A7).

Next, the first determination unit 12 determines the presence/absence of an actual attack using the processing result D and a preset threshold Th (step A8). In step A8, then, the first determination unit 12 outputs the result A of the determination of the presence/absence of an actual attack to the severity assessment unit 13.

The severity assessment unit 13 acquires the reported-case-of-exploitation presence/absence information K and the result A of the determination of the presence/absence of an actual attack. Next, the severity assessment unit 13 obtains the severity S by using the reported-case-of-exploitation presence/absence information K and the result A of the determination of the presence/absence of an actual attack and referring to the severity determination information 31 for determining the severity S (step A9).

Next, the severity assessment unit 13 stores the vulnerability identification information, the reported-case-of-exploitation presence/absence information K, the result A of the determination of an actual attack, the severity S, and information indicating the year, month, day, and hour of assessment of the severity S so as to be associated with one another in the storage device 20 or the like (step A10).

Next, the output-information generation unit 16 generates output information for presenting to the user at least information regarding the target vulnerability and the severity S of the target vulnerability (step A11). In step A11, next, the output-information generation unit 16 outputs the output information to the output device 40.

The above-described processing from step A1 to step A11 is executed for each of the one or more pieces of vulnerability information stored in the storage device 20. Furthermore, the processing from step A1 to step A11 is executed repetitively at a preset fixed interval or non-periodically.

### Effects of Example Embodiment 1

As described above, according to example embodiment 1, the severity of vulnerabilities can be assessed accurately by comprehensively recognizing the presence/absence of actual attacks without increasing the number of observation apparatuses 30.

Furthermore, in taking measures against vulnerabilities identified as a result of security-risk assessment, because the severity of the vulnerabilities can be assessed accurately, an increase in man-hours required for coding and testing can be suppressed even if system renovation and increase in the number of vulnerabilities to be resolved.

Furthermore, because the severity of vulnerabilities usable for actual attacks can be assessed accurately by determining severity using CVSS or the like, the cost-effectiveness of measures taken against vulnerabilities would be sufficient.

### [Program]

The program according to the example embodiment 1 may be a program that causes a computer to execute steps A1 to A11 shown in FIG. 5. By installing this program in a computer and executing the program, the information processing apparatus and the information processing method according to the example embodiment 1 can be realized. In this case, the processor of the computer performs processing to function as the vulnerability-information acquisition unit 14, the extraction unit 11, the log acquisition unit 15, the first determination unit 12, the severity assessment unit 13, and the output-information generation unit 16.

Also, the program according to the example embodiment 1 may be executed by a computer system constructed by a plurality of computers. In this case, for example, each computer may function as any of the vulnerability-information acquisition unit 14, the extraction unit 11, the log acquisition unit 15, the first determination unit 12, the severity assessment unit 13, and the output-information generation unit 16.

### Modification 1

The first determination unit 12 in example embodiment 1 determines the presence/absence of an actual attack using the calculated processing result D of definite integral processing and the preset threshold Th.

The first determination unit 12 according to modification 1 (second determination unit) uses model curve information indicating a model curve that has been created in advance and the calculated curve information to obtain a difference therebetween during a determination period T, and adopts the difference as a processing result D.

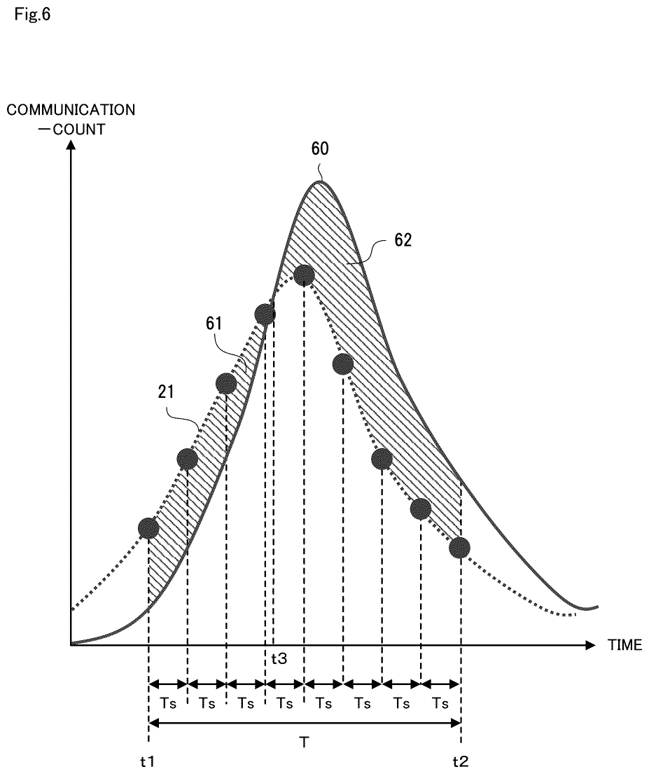

FIG. 6 is a diagram for describing an example of a difference between a model curve and a curve within a determination period. Specifically, as illustrated in FIG. 6, model curve 60 and curve 21 are used to obtain a difference (the sum of the area of region 61 (hatched area) in FIG. 6 and the area of region 62 (hatched area) in FIG. 6) within a determination period T, and the difference is used as a processing result D1.

Model curve 60 is determined using a result of an experiment, simulation, or the like. Alternatively, model curve 60 may be generated by machine learning, etc.

Specifically, first, the first determination unit 12 according to modification 1 (second determination unit) calculates a processing result Da by performing definite integral processing on model curve 60 from time point t1 to time point t3 (point of intersection) within the determination period and calculates a processing result Db by performing definite integral processing on curve 21 from time point t1 to time point t3, and obtains a difference Dsa (Db−Da; area of region 61 (hatched area) in FIG. 6) by subtracting the processing result Da from the processing result Db.

Next, the first determination unit 12 according to modification 1 (second determination unit) calculates a processing result Dc by performing definite integral processing on model curve 60 from time point t3 (point of intersection) to time point t2 within the determination period and calculates a processing result Dd by performing definite integral processing on curve 21 from time point t3 to time point t2, and obtains a difference Dsb (Dc−Dd; area of region 62 (hatched area) in FIG. 6) by subtracting the processing result Dd from the processing result Dc.

Next, the first determination unit 12 according to modification 1 (second determination unit) obtains the sum of difference Dsa and difference Dsb to obtain a processing result D1 (=Dsa+Dsb).

Note that, in a case in which there are a plurality of points t3 (points of intersection), the result obtained by performing a definite integral of the “absolute value” of f(t)−g(t) from t1 to t2 is adopted as D1, where function f(t) represents the model curve and function g(t) represents curve 21.

Next, the first determination unit 12 according to modification 1 (second determination unit) determines the presence/absence of an actual attack using the calculated processing result D1 and a preset threshold Th1. The threshold Th1 is information for determining the presence/absence of an actual attack. For example, the threshold Th1 is a value determined based on a result of an experiment, simulation, or the like.

If the processing result D1 is greater than or equal to the threshold Th1, the first determination unit 12 according to modification 1 (second determination unit) determines that an actual attack is present and sets “1” to a result A of the determination of an actual attack. If the processing result D1 is smaller than the threshold Th1, the first determination unit 12 according to modification 1 (second determination unit) determines that no actual attack is present and sets “0” to the result A of the determination of an actual attack.

As described above, according to modification 1, determination can be performed while taking into consideration a characteristic of a trend in which the number of times a vulnerability is exploited changes as time elapses.

### Modification 2

The severity assessment unit 13 according to example embodiment 1 obtains the severity S by using the reported-case-of-exploitation presence/absence information K and the result A of the determination of the presence/absence of an actual attack and referring to the severity determination information 31 for determining the severity S.

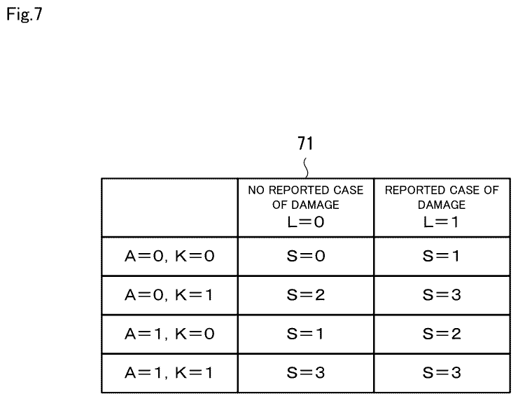

The severity assessment unit 13 according to modification 2 first obtains the severity S using severity determination information 71 such as that illustrated in FIG. 7. FIG. 7 is a diagram for describing the data structure of the severity determination information according to modification 2. The severity determination information 71 is information for determining the severity S based on reported-case-of-damage presence/absence information L and the combination of the reported-case-of-exploitation presence/absence information K and the result A of the determination of the presence/absence of an actual attack.

The reported-case-of-damage presence/absence information L is information indicating the presence/absence of a reported case of damage corresponding to the target vulnerability information that has been generated based on damage information in a news article provided by mass media or the like, or damage information in a security report or the like, for example. For example, it is conceivable to store the reported-case-of-damage presence/absence information L in the storage device 20 or the like.

If the reported-case-of-damage presence/absence information indicates that no reported case of damage is present (L=0), the reported-case-of-exploitation presence/absence information indicates that no reported case of exploitation is present (K=0), and the result of the determination of an actual attack is that no actual attack is present (A=0) in a case in which the severity determination information 71 in FIG. 7 is used, the severity is set to “0” (S=0).

If the reported-case-of-damage presence/absence information indicates that a reported case of damage is present (L=1), the reported-case-of-exploitation presence/absence information indicates that no reported case of exploitation is present (K=0), and the result of the determination of an actual attack is that no actual attack is present (A=0), the severity is set to “1” (S=1).

If the reported-case-of-damage presence/absence information indicates that reported case of damage is present (L=0), the reported-case-of-exploitation presence/absence information indicates that no reported case of exploitation is present (K=1), and the result of the determination of an actual attack is that an actual attack is present (A=0), the severity is set to “2” (S=2).

If the reported-case-of-damage presence/absence information indicates that a reported case of damage is present (L=1), the reported-case-of-exploitation presence/absence information indicates that no reported case of exploitation is present (K=1), and the result of the determination of an actual attack is that an actual attack is present (A=0), the severity is set to “3” (S=3).

If the reported-case-of-damage presence/absence information indicates that a reported case of damage is present (L=0), the reported-case-of-exploitation presence/absence information indicates that a reported case of exploitation is present (K=0), and the result of the determination of an actual attack is that no actual attack is present (A=1), the severity is set to “1” (S=1).

If the reported-case-of-damage presence/absence information indicates that a reported case of damage is present (L=1), the reported-case-of-exploitation presence/absence information indicates that a reported case of exploitation is present (K=0), and the result of the determination of an actual attack is that no actual attack is present (A=1), the severity is set to “2” (S=2).

If the reported-case-of-damage presence/absence information indicates that a reported case of damage is present (L=0), the reported-case-of-exploitation presence/absence information indicates that a reported case of exploitation is present (K=1), and the result of the determination of an actual attack is that no actual attack is present (A=1), the severity is set to “3” (S=3).

If the reported-case-of-damage presence/absence information indicates that a reported case of damage is present (L=1), the reported-case-of-exploitation presence/absence information indicates that a reported case of exploitation is present (K=1), and the result of the determination of an actual attack is that no actual attack is present (A=1), the severity is set to “3” (S=3).

Next, the severity assessment unit 13 according to modification 2 stores the vulnerability identification information, the reported-case-of-exploitation presence/absence information K, the result A of the determination of an actual attack, the severity S, and information indicating the year, month, day, and hour of assessment of the severity S that are related to the target vulnerability so as to be associated with one another in the storage device 20.

According to modification 2, the severity of vulnerabilities can be assessed accurately by more comprehensively recognizing the presence/absence of actual attacks than in example embodiment 1 without increasing the number of observation apparatuses 30.

### Modification 3

The severity assessment unit 13 according to modification 2 obtains the severity S using severity determination information 71 such as that illustrated in FIG. 7.

The severity assessment unit 13 according to modification 3 obtains the severity S using the function shown in Math. 1. The function min(x, y) is a function that returns the smaller one of x and y.

$$S = min ( 3 , L + A + K \times 2 ) \qquad [ Math . 1 ]$$

The severity S may be obtained by representing each of the reported-case-of-damage presence/absence information, the reported-case-of-exploitation presence/absence information, and the result of the determination of the presence/absence of an actual attack as a risk value including a decimal point instead of 1 or 0. For example, for each of damage, exploitation, and actual attack, the user sets the reliability of the source of information and uses the reliability as a risk value. Alternatively, the ratio of regions in which each of damage, exploitation, and actual attack has been observed relative to the entire world may be used as a risk value.

According to modification 3, risk values can be set flexibly, and severity values can be calculated without treating minor events overly seriously.

### [Physical Configuration]

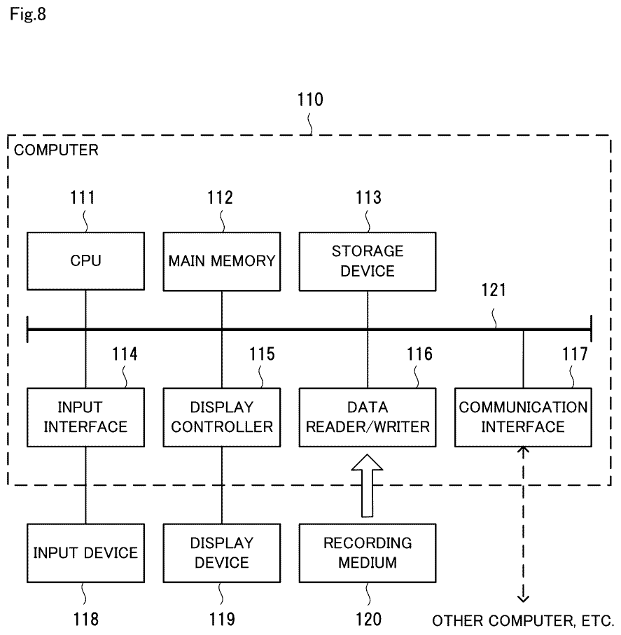

Here, a computer that realizes the information processing apparatus by executing the program according to the example embodiment 1 and the modifications 1 to 3 will be described with reference to FIG. 8. FIG. 8 is a diagram illustrating an example of a computer that realizes the information processing apparatus in the example embodiment 1 and the modifications 1 to 3.

As shown in FIG. 8, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to the example embodiment 1 and the modifications 1 to 3, which has been stored in the storage device 113, in the main memory 112 and performs various operations by executing the program in a predetermined order. The main memory 112 is typically a volatile storage device such as a DRAM (Dynamic Random Access Memory). Also, the program according to the example embodiment 1 and the modifications 1 to 3 is provided in a state being stored in a computer-readable recording medium 120. Note that the program according to this example embodiment may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the information processing apparatus 10 according to this example embodiment can also be realized by using hardware corresponding to each unit. Furthermore, a portion of the information processing apparatus 10 may be realized by a program, and the remaining portion realized by hardware.

Although the example embodiment has been described with reference to exemplary embodiments, the example embodiments is not limited to the above example embodiments. Within the scope of the example embodiment, various changes that can be understood by those skilled in the art can be made to the configuration and details of the example embodiment.

### INDUSTRIAL APPLICABILITY

As described above, the severity of vulnerabilities can be assessed accurately by comprehensively recognizing the presence/absence of actual attacks. In addition, it is useful in fields where attack analysis is necessary.

### REFERENCE SIGNS LIST

10 Information processing apparatus
11 Extraction unit
12 First determination unit
13 Severity assessment unit
14 Vulnerability-information acquisition unit
15 log acquisition unit
16 Output-information generating unit
20 Storage device
30 Observation apparatus
40 Output device
50 Network
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. An information processing apparatus comprising:
at least one memory storing instructions; and
at least one processor configured to execute the instructions to:
extract, from vulnerability description information that is included in vulnerability information stored in a storage device and that indicates a description regarding a vulnerability, first protocol information indicating a first protocol for communication and port number information indicating a port number for communication;
extract second protocol information indicating a second protocol and transmission-destination port number information indicating a transmission-destination port number from a log obtained as a result of an observation apparatus connected to a network performing communication using the first protocol and the port number; (b) generate frequency distribution information by using the extracted second protocol and transmission-destination port number and obtaining the number of instances of communication during each of a plurality of preset sampling periods that are arranged in a time series within a preset determination period; (c) calculate curve information indicating a curve by executing smoothing processing on the generated frequency distribution information; (d) calculate a processing result by executing definite integral processing on the generated curve information; and (e) determines presence/absence of an actual attack using the calculated processing result and a preset threshold; and
acquire reported-case-of-exploitation presence/absence information that is included in the vulnerability information and that indicates presence/absence of a reported case of exploitation of the target vulnerability, and calculate a severity based on the reported-case-of-exploitation presence/absence information and a result of the determination of the presence/absence of an actual attack.

2. The information processing apparatus according to claim 1,
wherein the one or more processors further;
acquires reported-case-of-damage presence/absence information indicating presence/absence of a reported case of damage corresponding to the target vulnerability information, and calculates the severity based on the reported-case-of-damage presence/absence information, the reported-case-of-exploitation presence/absence information, and the result of the determination of the presence/absence of an actual attack.

3. The information processing apparatus according to claim 1
wherein the one or more processors further:
in place of the executes processes below: (a) extract second protocol information indicating a second protocol and transmission-destination port number information indicating a transmission-destination port number from a log obtained as a result of an observation apparatus connected to a network performing communication using the first protocol and the port number; (b) generate frequency distribution information by using the extracted second protocol and transmission-destination port number and obtaining the number of instances of communication during each of a plurality of preset sampling periods that are arranged in a time series within a preset determination period; (c) calculate curve information indicating a curve by executing smoothing processing on the generated frequency distribution information; (f) calculate a difference between a model curve that has been generated in advance and the curve within the determination period using the curve information and model curve information indicating the model curve; and (g) determines presence/absence of an actual attack using the calculated difference and a preset threshold.

4. The information processing apparatus according to claim 1,
wherein the one or more processors further:
if the first protocol information and the port number information cannot be extracted from the vulnerability description information, extracts the first protocol and the port number from text information in a location where an exploit code corresponding to the target vulnerability is publicly disclosed.

5. An information processing method in which an information processing apparatus executes:
an extraction processing of extracting, from vulnerability description information that is included in vulnerability information stored in a storage device and that indicates a description regarding a vulnerability, first protocol information indicating a first protocol for communication and port number information indicating a port number for communication;
a first determination processing of: (a) extracting second protocol information indicating a second protocol and transmission-destination port number information indicating a transmission-destination port number from a log obtained as a result of an observation apparatus connected to a network performing communication using the first protocol and the port number; (b) generating frequency distribution information by using the extracted second protocol and transmission-destination port number and obtaining the number of instances of communication during each of a plurality of preset sampling periods that are arranged in a time series within a preset determination period; (c) calculating curve information indicating a curve by executing smoothing processing on the generated frequency distribution information; (d) calculating a processing result by executing definite integral processing on the generated curve information; and (e) determining presence/absence of an actual attack using the calculated processing result and a preset threshold; and
a severity assessment processing of acquiring reported-case-of-exploitation presence/absence information that is included in the vulnerability information and that indicates presence/absence of a reported case of exploitation of the target vulnerability, and calculating a severity based on the reported-case-of-exploitation presence/absence information and a result of the determination of the presence/absence of an actual attack.

6. The information processing method according to claim 5,
wherein, in the severity assessment processing, reported-case-of-damage presence/absence information indicating presence/absence of a reported case of damage corresponding to the target vulnerability information is further acquired, and the severity is calculated based on the reported-case-of-damage presence/absence information, the reported-case-of-exploitation presence/absence information, and the result of the determination of the presence/absence of an actual attack.

7. The information processing method according to claim 5, wherein
the information processing apparatus executes, in place of the first determination processing, second determination processing of: (a) extracting second protocol information indicating a second protocol and transmission-destination port number information indicating a transmission-destination port number from a log obtained as a result of an observation apparatus connected to a network performing communication using the first protocol and the port number; (b) generating frequency distribution information by using the extracted second protocol and transmission-destination port number and obtaining the number of instances of communication during each of a plurality of preset sampling periods that are arranged in a time series within a preset determination period; (c) calculating curve information indicating a curve by executing smoothing processing on the generated frequency distribution information; (f) calculating a difference between a model curve that has been generated in advance and the curve within the determination period using the curve information and model curve information indicating the model curve; and (g) determining presence/absence of an actual attack using the calculated difference and a preset threshold.

8. A non-transitory computer readable recording medium that includes a program recorded thereon, the program causing a computer to execute:
an extraction processing of extracting, from vulnerability description information that is included in vulnerability information stored in a storage device and that indicates a description regarding a vulnerability, first protocol information indicating a first protocol for communication and port number information indicating a port number for communication;
a first determination processing of: (a) extracting second protocol information indicating a second protocol and transmission-destination port number information indicating a transmission-destination port number from a log obtained as a result of an observation apparatus connected to a network performing communication using the first protocol and the port number; (b) generating frequency distribution information by using the extracted second protocol and transmission-destination port number and obtaining the number of instances of communication during each of a plurality of preset sampling periods that are arranged in a time series within a preset determination period; (c) calculating curve information indicating a curve by executing smoothing processing on the generated frequency distribution information; (d) calculating a processing result by executing definite integral processing on the generated curve information; and (e) determining presence/absence of an actual attack using the calculated processing result and a preset threshold; and
a severity assessment processing of acquiring reported-case-of-exploitation presence/absence information that is included in the vulnerability information and that indicates presence/absence of a reported case of exploitation of the target vulnerability, and calculating a severity based on the reported-case-of-exploitation presence/absence information and a result of the determination of the presence/absence of an actual attack.

9. The non-transitory computer readable recording medium according to claim 8,
wherein the program causes the computer to, in the severity assessment processing, further acquire reported-case-of-damage presence/absence information indicating presence/absence of a reported case of damage corresponding to the target vulnerability information, and calculate the severity based on the reported-case-of-damage presence/absence information, the reported-case-of-exploitation presence/absence information, and the result of the determination of the presence/absence of an actual attack.

10. The non-transitory computer readable recording medium according to claim 8 including a program recorded thereon, the program causing the computer to execute:
in place of the first determination processing, second determination processing of: (a) extracting second protocol information indicating a second protocol and transmission-destination port number information indicating a transmission-destination port number from a log obtained as a result of an observation apparatus connected to a network performing communication using the first protocol and the port number; (b) generating frequency distribution information by using the extracted second protocol and transmission-destination port number and obtaining the number of instances of communication during each of a plurality of preset sampling periods that are arranged in a time series within a preset determination period; (c) calculating curve information indicating a curve by executing smoothing processing on the generated frequency distribution information; (f) calculating a difference between a model curve that has been generated in advance and the curve within the determination period using the curve information and model curve information indicating the model curve; and (g) determining presence/absence of an actual attack using the calculated difference and a preset threshold.
